(19) United States
(12) Patent Application Publication
(10) Pub. No.: US 2023/0385188 A1
(43) Pub. Date: Nov. 30, 2023

(54) METHOD, NON-TRANSITORY COMPUTER-READABLE MEDIUM, AND APPARATUS FOR ANALYZING SOURCE CODE

(71) Applicant: Mitsubishi Electric Corporation, Chiyoda-ku, Tokyo (JP)

(72) Inventors: Masaki FUJITA, Chiyoda-ku, Tokyo (JP); Yuki HIKAWA, Chiyoda-ku, Tokyo (JP)

(73) Assignee: Mitsubishi Electric Corporation, Chiyoda-ku, Tokyo (JP)

(21) Appl. No.: 18/247,902

(22) PCT Filed: Jul. 28, 2021
(86) PCT No.: PCT/JP2021/027889

§ 371 Date: Apr. 5, 2023

(30) Foreign Application Priority Data
Nov. 30, 2020 (JP) 2020-198372

(51) Int. Cl. G06F 11/36

(52) U.S. Cl. CPC G06F 11/3692

(57) ABSTRACT

The aim is to detect a portion(s) that may include a latent defect(s) under the impact of a global variable in a source code. A method for analyzing a source code using one or a plurality of processors is provided. The method includes obtaining a defect pattern of a program, obtaining a source code of the program, extracting CRUD information associated with a global variable from the source code, identifying a latent defect from the CRUD information based on the defect pattern, and outputting a CRUD matrix containing information of the latent defect.

### TECHNICAL FIELD

This disclosure relates to analysis of source codes, more particularly to drawing up of a CRUD matrix of global variables.

### BACKGROUND ART

In recent years, the scale of source code in software development is growingly expanding in recent years. Such a growing scale of source code continues to increase any latent defects included in the source code. The global variable can be referenced by any function within a project, the extent of impact of which, therefore, may be difficult to detect and analyze.

In regard to the source code analysis, Japanese Patent Laying-Open No. 2020-119348 (patent literature 1), for example, describes a method for analysis characterized as below. This method starts with detecting a call relationship among a plurality of modules included in a target program to be analyzed. Then, a first one of the plurality of modules is activated. In response to startup of the first module, a query is created for a database. This query is then obtained to determine whether the query satisfies a predetermined format. In case the query fails to satisfy the predetermined format, a second one of the modules, which is the caller of the first module, is then activated. The search of the module to be activated continues, tracing back the callers, until a query that satisfies the predetermined format is obtained. Then, the method outputs an analysis result indicating the query that satisfies the predetermined format and the module activated when this query was created.

### CITATION LIST

### Patent Literature

PTL 1: Japanese Patent Laying-Open No. 2020-119348

### SUMMARY OF THE INVENTION

### Technical Problem

The technology described in Patent Literature 1, however, fails to detect a portion(s) that may include any latent defect(s) within the source code under the impact of global variables. A technology is desirably developed that can detect such a portion that may include a latent defect(s) within the source code under the impact of global variables.

To address these issues of the known art, this disclosure is directed to providing, in an aspect, a technology that enables detection of a portion(s) that may include any latent defect(s) within the source code under the impact of global variables.

### Solution to Problem

In an embodiment, a method for analysis is provided, in which a source code is analyzed using one or a plurality of processors. This method includes:
obtaining a defect pattern of a program;
obtaining a source code of the program;
extracting CRUD information associated with a global variable from the source code;
identifying a latent defect from the CRUD information based on the defect pattern; and
outputting a CRUD matrix containing information of the latent defect.

### Advantageous Effects of Invention

According to an embodiment of the technology disclosed herein, a portion(s) that may include any latent defect(s) within the source code under the impact of global variables may be successfully detectable.

The foregoing and other objects, features, aspects and advantages of this disclosure will become more apparent from the following detailed description when taken in conjunction with the accompanying drawings.

### BRIEF DESCRIPTION OF THE DRAWINGS

FIG. 1 is a block diagram that illustrates exemplified functional blocks of a CRUD matrix generating apparatus 100 according to an embodiment.

FIG. 2 is a block diagram that illustrates exemplified hardware elements of the CRUD matrix generating apparatus 100.

FIG. 3 is a table showing an example of CRUD information 300 according to an embodiment.

FIG. 4 is a table showing an exemplified latent defect pattern 111 according to an embodiment.

FIG. 5 is a table showing an exemplified CRUD matrix 113 according to an embodiment.

FIG. 6 is a flow chart of exemplified processing steps of registering the latent defect pattern 111 in the CRUD matrix generating apparatus 100.

FIG. 7 is a flow chart of exemplified processing steps from the step of obtaining a source code 112 to the step of generating the CRUD matrix 113 in the CRUD matrix generating apparatus 100.

FIG. 8 is a flow chart of exemplified processing steps of extracting the CRUD information in the CRUD matrix generating apparatus 100.

FIG. 9 is a flow chart of exemplified processing steps of identifying a latent defect portion in the CRUD matrix generating apparatus 100.

FIG. 10 is a table showing an example of data 1000 indicating latent defect portions according to an embodiment.

FIG. 11 is a flow chart of exemplified processing steps of generating the CRUD matrix 113 in the CRUD matrix generating apparatus 100.

FIG. 12 is a block diagram that illustrates exemplified functional blocks of a CRUD matrix generating apparatus 1200 according to an embodiment.

FIG. 13 is a drawing that illustrates exemplified tasks.

FIG. 14 is a table showing an exemplified latent defect pattern 1211 per task.

FIG. 15 is a table showing an exemplified CRUD matrix 1215 per task.

FIG. 16 is a flow chart of exemplified steps of combining tasks in the CRUD matrix generating apparatus 1200.

FIG. 17 is a flow chart of exemplified processing steps of identifying a latent defect portion in the CRUD matrix generating apparatus 1200.

FIG. 18 is a block diagram that illustrates exemplified functional blocks of a CRUD matrix generating apparatus 1850 according to an embodiment.

FIG. 19 is a diagram that illustrates processing steps of extracting an output file 1851 of inter-task dependency.

FIG. 20 is a table showing an example of the output file 1851 of inter-task dependency.

FIG. 21 is a flow chart of exemplified processing steps until the output file 1851 of inter-task dependency is outputted in the CRUD matrix generating apparatus 1850.

FIG. 22 is a block diagram that illustrates exemplified functional blocks of a CRUD matrix generating apparatus 1800 according to an embodiment.

FIG. 23 is a table showing an exemplified latent defect pattern 1811.

FIG. 24 is a table showing an exemplified CRUD matrix differential file 1815.

FIG. 25 is a flow chart of exemplified processing steps of generating a CRUD matrix differential file 1815 in the CRUD matrix generating apparatus 1800.

### DESCRIPTION OF EMBODIMENTS

Embodiments of the technical idea according to the disclosure are hereinafter described with reference to the accompanying drawings. In the description below, like components are illustrated with the same reference signs. Also, they are referred to likewise and have similar functional features. Such components, therefore, will not be repeatedly described in detail.

### First Embodiment

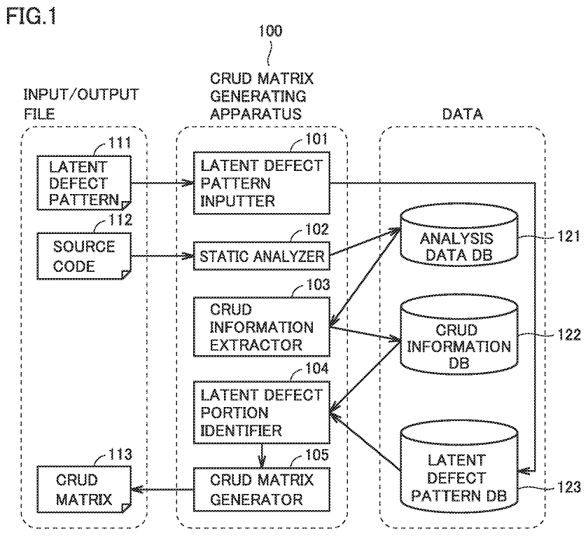

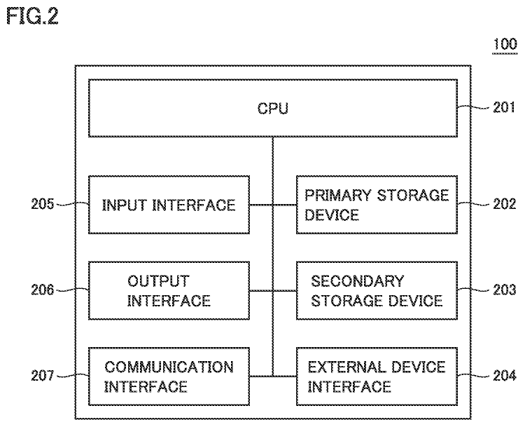

A CRUD matrix generating apparatus 100 according to this embodiment is for use in analyzing the source code of an optional program and identifying a portion(s) of the source code that may include any latent defect(s) (hereinafter, referred to as “latent defect portion”). CRUD matrix generating apparatus 100 generates a CRUD matrix in which information of a latent defect portion (s) is highlighted and displayed. The latent defect portion includes a portion(s) that may include a defect(s) attributed to a global variable(s). First, functional and hardware elements of CRUD matrix generating apparatus 100 are hereinafter described with reference to FIGS. 1 and 2.

FIG. 1 is a block diagram that illustrates exemplified functional blocks of CRUD matrix generating apparatus 100 according to this embodiment. In an aspect, the functional blocks illustrated in FIG. 1 may be actualized under the collaboration of hardware of FIG. 2 with software.

CRUD matrix generating apparatus 100 is equipped with a latent defect pattern inputter 101, a static analyzer 102, a CRUD information extractor 103, a latent defect portion identifier 104, and a CRUD matrix generator 105. Input and output files to and from CRUD matrix generating apparatus 100 contain a latent defect pattern 111, a source code 112, and a CRUD matrix 113. Data to be stored in CRUD matrix generating apparatus 100 is stored in an analysis data DB (database) 121, a CRUD information DB 122, and a latent defect pattern DB 123. In an aspect, these databases may be installed in a storage device of CRUD matrix generating apparatus 100 (not illustrated in the drawings) or may be stored in an external device.

Latent defect pattern inputter 101 receives the input of latent defect pattern 111. Latent defect pattern inputter 101 stores the received latent defect pattern 111 in latent defect pattern DB 123. Latent defect pattern 111 may include, for example, a combination of conditions set for creation, reading, updating and deletion of a global variable that may cause a latent defect(s) in the source code of a certain program (hereinafter, may be referred to as “Create (C)”, Read (R), Update (U) and Delete (D)”).

The Create (C) of the global variable includes creating instances of a class in an object-oriented program or dynamically securing a memory region for the variable. Dynamically securing a memory for the variable may be comparable to, for example, execution of the malloc( ) function in C language. The Read (R) of a global variable is reading of data stored in the variable. The Update (U) of a global variable is update or overwrite of data stored in the variable. The Delete (D) includes deletion of the instances or release of the memory region dynamically secured for variables.

Static analyzer 102 obtains and analyzes source code 112 to generate analysis data containing reference relation-related information of global variables and functions. Static analyzer 102 stores the generated analysis data in analysis data DB 121. In an aspect, source code 112 may include a source code in an optional language. Source code 112 may be a source code in a language that requires compiling of C language or may be a source code in a language run by an interpreter of, for example, Python. In other aspects, static analyzer 102 may be actualized by using a static analysis tool in which a known static analysis technique is employed.

In an aspect, latent defect pattern inputter 101 and static analyzer 102 may include an input interface to receive a user's input and/or a communication interface to obtain data/information transmitted from other apparatuses.

CRUD information extractor 103 reads the analysis data from analysis data DB 121 and analyzes the read data to generate CRUD information indicating which function is used for Create (C), Read (R), Update (U) and Delete (D) of the global variable(s) in source code 112 and the number of runs of these processing actions. CRUD information extractor 103 stores the generated CRUD information in CRUD information DB 122. The Create (C), Read (R), Update (U) and Delete (D) may be hereinafter collectively referred to as “CRUD process”. The number of runs of the “CRUD process” (or CRUD information) may be rephrased as the number of runs of Create (C), Read (R), Update (U), Delete (D). The CRUD information extracted by CRUD information extractor 103 includes the number of runs of the CRUD process (CRUD information) for each global variable by each function.

Latent defect portion identifier 104 obtains latent defect pattern 111 from latent defect pattern DB 123, while obtaining the CRUD information from CRUD information DB 122. Latent defect portion identifier 104 identifies a latent defect portion(s) based on latent defect pattern 111 and the CRUD information. Latent defect portion identifier 104 outputs information of the latent defect portion(s) and the CRUD information to CRUD matrix generator 105.

CRUD matrix generator 105 generates and outputs CRUD matrix 113 based on information of the latent defect portion(s) and the CRUD information received from latent defect portion identifier 104. CRUD matrix 113 contains information highlighting and displaying the latent defect portion(s) in CRUD matrix 113. In an aspect, highlighting and displaying the latent defect portion(s) in CRUD matrix 113 may include, in a column for the defect portion, color change, ruled line drawing, font size change, highlighted text, text color change or combination of two or more of these display changes. A user, by looking at CRUD matrix 113 presenting a highlighted defect portion(s), may easily find the latent defect(s) attributed to the global variables(s) included in source code 112.

In an aspect, analysis data DB 121, CRUD information DB 122 and latent defect pattern DB 123 may be each a relational DB or may include data in an optional format, for example, JSON (JavaScript (registered trademark) Object Notation). In other aspects, CRUD matrix generating apparatus 100 may store CRUD matrix 113 and data of the latent defect portion(s) obtained earlier or generated earlier in a memory device (not illustrated in the drawings).

FIG. 2 is a block diagram that illustrates exemplified hardware elements of CRUD matrix generating apparatus 100. CRUD matrix generating apparatus 100 includes a CPU (Central Processing Unit) 201, a primary storage device 202, a secondary storage device 203, an external device interface 204, an input interface 205, an output interface 206, and a communication interface 207.

CPU 201 may be allowed to run a program(s) to actualize various functional features of CRUD matrix generating apparatus 100. CPU 201 may include, for example, at least one integrated circuit. The integrated circuit may include, for example, at least one CPU, at least one FPGA (Field Programmable Gate Array) or these devices combined and used.

In primary storage device 202 are storable a program(s) run by CPU 201 and data referenced by CPU 201. In an aspect, primary storage device 202 may be or may include a DRAM (Dynamic Random Access Memory) or a SRAM (Static Random Access Memory).

Secondary storage device 203 is a non-volatile memory, in which a program(s) run by CPU 201 and data referenced by CPU 201 may be storable. In this instance, CPU 201 runs a program read out from secondary storage device 203 into primary storage device 202. Also, CPU 201 references data read out from secondary storage device 203 into primary storage device 202. In an aspect, secondary storage device 203 may be or may include a HDD (Hard Disk Drive), SSD (Solid State Drive), EPROM (Erasable Programmable Read Only Memory), EEPROM (Electrically Erasable Programmable Read Only Memory) or a flash memory.

External device interface 204 may be connectable to any optional external device, for example, printer, scanner and/or external HDD. In an aspect, external device interface 204 may be or may include a USB (Universal Serial Bus) terminal.

Input interface 205 may be connectable to an optional input device(s), for example, a keyboard, mouse, touchpad, and/or gamepad. In an aspect, input interface 205 may include a USB terminal, PS/2 terminal and Bluetooth (registered trademark) module.

Output interface 206 may be connectable to an optional output device(s), for example, a CRT-based display, or liquid crystal display or organic EL (Electro-Luminescence) display. In an aspect, output interface 206 may be or may include a USB terminal, D-sub terminal, DVI (Digital V&isual Interface) terminal and/or HDMI (registered trademark; High-Definition Multimedia Interface) terminal.

Communication interface 207 may be connected to a wired or wireless network device. In an aspect, communication interface 207 may be or may include a wired LAN (Local Area Network) port or a Wi-Fi (registered trademark; Wireless Fidelity) module. In other aspects, communication interface 207 may transmit and receive data using a communication protocol, for example, TCP/IP (Transmission Control Protocol/Internet Protocol) or UDP (User Datagram Protocol).

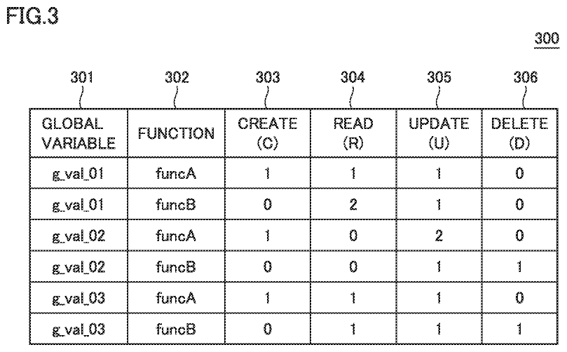

Next, CRUD matrix 113, latent defect pattern 111 and CRUD information generated or referenced by CRUD matrix generating apparatus 100 are hereinafter described in detail with reference to FIGS. 3 to 5.

FIG. 3 is a table showing an example of CRUD information 300 according to this embodiment. CRUD information 300 indicates the number of runs of the CRUD process for each global variable by each function. CRUD information 300 may be stored in CRUD information DB 122 in the form of a table as illustrated in, for example, FIG. 3. In an aspect, CRUD information 300 may be presented in an optional data format, for example, JSON. CRUD information 300 includes, as elements, global variable 301, function 302, Create (C) 303, Read (R) 304, Update (U) 305, and Delete (D) 306.

Global variable 301 indicates the global variables included in source code 112. Function 302 indicates functions using the global variables. In the example illustrated in FIG. 3, the function “funcA” uses the global variables; “g_val_01,a” g_val_02”, and “g_val_03”. The function “funcB” also uses the global variables; “g_val_01,a” g_val_02”, and “g_val_03”.

Create (C) 303 indicates how many times the global variable is created. Read (R) 304 indicates how many times the global variable is referenced. Update (U) 305 indicates how many times the global variable is updated. Delete (D) 306 indicates how many times the global variable is deleted. Taking, for example, the first row in the table showing CRUD information 300, the global variable “g_val_01” is created once, referenced once and updated once but is never deleted by the function “funcA”. Taking, for example, the fourth row in the table showing CRUD information 300, the global variable “g_val_02” is updated once and deleted once but is never created or referenced by the function “funcB”.

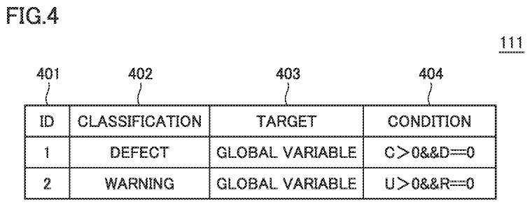

FIG. 4 is a table showing an example of latent defect pattern 111 according to this embodiment. Latent defect pattern 111 defines the combination of the numbers of runs of the CRUD process that may lead to any problem in the CRUD matrix. Latent defect pattern 111 may be stored in latent defect pattern DB 123 in the form of a table as illustrated in, for example, FIG. 4. In an aspect, latent defect pattern 111 may be presented in any optional data format, for example, JSON. In other aspects, latent defect pattern inputter 101 may receive, instead of receiving data input in the format illustrated in FIG. 4, information input in an optional format containing a latent defect pattern for each global variable.

Latent defect pattern 111 includes, as elements, ID (Identifier) 401, classification 402, target 403 and condition 404. ID 401 uniquely identifies each defect. Classification 402 indicates the classification of each defect. In the example illustrated in FIG. 4, classification 402 includes a defect(s) and a warning(s). Each defect may be classified based on, for example, the degree of possible hazard. Target 403 indicates a target to be analyzed. Target 403 may include, for example, a global variable(s) and a function(s). In an aspect, target 403 may include a class(s) in an object-oriented program. Condition 404 indicates a condition set for detection of any latent defect portion. Condition 404 may be defined by the combination of the numbers of runs of the CRUD process.

Taking, for example, the first row in the table of FIG. 4, CRUD matrix generating apparatus 100 determines that, in target 403 “global variable”, a latent defect as indicated by “a defect” in classification 402 lies in a certain global variable, upon confirmation that condition 404, “C>0&&D==0 (Create (C))”, is done at least once but Delete (D) is never done. The first row in the table in FIG. 4 indicates that, while the instances of the global variable have been generated (or memory has been dynamically secured for the global variable, the instances of the global variable are yet to be discarded (or memory dynamically secured for the global variable is yet to be released). This case may suggest the risk of data leakage from the memory.

Taking, for example, the second row in the table of FIG. 4, CRUD matrix generating apparatus 100 determines that, in target 403 “global variable”, a latent defect as indicated by a “warning” in classification 402 lies in a certain global variable, upon confirmation that condition 404, “U>0&&R==0 (Update (U)”, is done at least once but “Read (R) is never done. The second row in the table of FIG. 4 indicates that the global variable is updated but is never read since then. In such an event, source code 112 may include a meaningless process(es).

In an aspect, in case a “function” is specified in target 403, CRUD matrix generating apparatus 100 adds up pieces of CRUD information of the functions for all of global variables. CRUD matrix generating apparatus 100 determines whether the added-up result of each function corresponds with a pattern included in condition 404. When the added-up result of a certain function corresponds with the pattern included in condition 404, CRUD matrix generating apparatus 100 determines that a latent defect(s) lies in the relevant function.

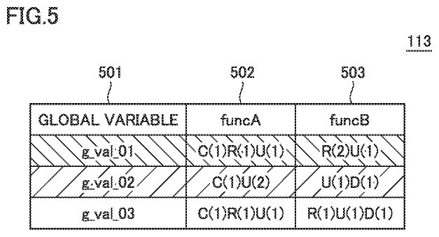

FIG. 5 is a table showing an example of CRUD matrix 113 according to this embodiment. CRUD matrix 113 contains information of the number of runs of the CRUD process for each global variable by each function. CRUD matrix 113 presents highlighted display of the latent defect portion(s).

CRUD matrix 113 includes, as elements, a global variable 501 and functions 502 and 503. The functions, “funcA” and “funcB”, are illustrated in FIG. 5 by way of an example. In an aspect, CRUD matrix 113 may include, as elements, an optional number of functions; one or more functions, within source code 112.

Taking, for example, the first row in the table of FIG. 5, the global variable 501, “g_val_01”, is created (C) once, read (R) once, and updated (U) once by the function 502, “funcA”. The global variable 501, “g_val_01”, is read (R) twice and updated (U) once by the function 503, “funcB”. The first row in FIG. 5, which corresponds with condition 404 “C>0&&D==0” in the first row of FIG. 4, is highlighted and displayed.

Taking, for example, the second row in the table of FIG. 5, the global variable 501, “g_val_02”, is created (C) once and updated (U) twice by the function 502, “funcA”. The global variable 501, “g_val_02”, is updated (U) once and deleted (D) once by the function 503, “funcB”. The second row in FIG. 5, which corresponds with condition 404 “U>0&&R==0” in the second row of FIG. 4, is highlighted and displayed. The highlighted display used in CRUD matrix 113 may be suitably changed according to classification 402.

The third line in FIG. 5 is not highlighted because this row corresponds with none of the conditions in condition 404 of FIG. 4. Thus, CRUD matrix generating apparatus 100 generates CRUD matrix 113 in which any latent defect portion is highlighted and displayed. A user, by looking at CRUD matrix 113, may be able to find a portion(s) that may include a latent defect(s) attributed to a global variable(s) within source code 112.

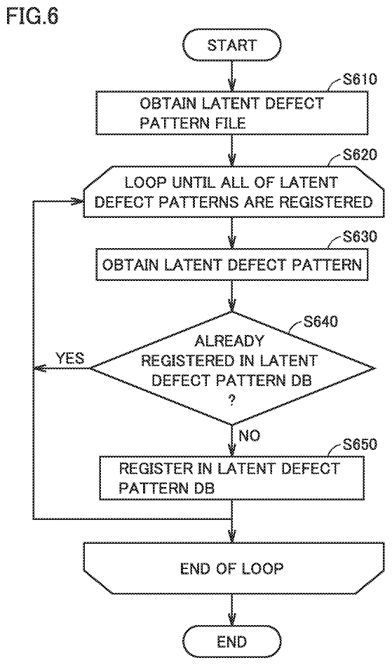

Next, a process carried out by CRUD matrix generating apparatus 100 is hereinafter described with reference to FIGS. 6 to 11. The process described below includes processing steps from the step of analyzing source code 112 to the step of outputting CRUD matrix 113. In an aspect, CPU 201 may read out a program for the processing steps of FIGS. 6 to 9 and FIGS. 11 and 12 from secondary storage device 203 into primary storage device 202 and then run the read program. In other aspects, the processing steps in whole or in part are also feasible in the form of a combination of circuit elements configured to execute these processing steps.

FIG. 6 is a flow chart of exemplified processing steps of registering latent defect pattern 111 in CRUD matrix generating apparatus 100. In step S610, CPU 201 obtains, through input interface 205, a latent defect pattern file containing one or a plurality of latent defect patterns 111. In an aspect, CPU 201 may obtain the latent defect pattern file through external device interface 204 or communication interface 207.

In step S620, CPU 201 repeatedly carries out the steps within a loop until all of latent defect patterns 111 are successfully registered. In step S630, CPU 201 obtains one latent defect pattern 111 from the latent defect pattern file.

In step S640, CPU 201 determines whether latent defect pattern 111 obtained in step S630 has already been registered in latent defect pattern DB 123. CPU 201 proceeds to step S620 when CPU 201 determines that latent defect pattern 111 obtained in step S630 has already been registered in latent defect pattern DB 123 (YES in step S640). Otherwise (NO in step S640), CPU 201 proceeds to step S650. In step S650, CPU 201 registers latent defect pattern 111 obtained in step S630 in latent defect pattern DB 123.

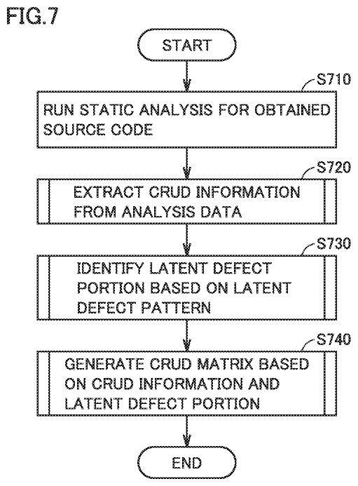

FIG. 7 is a flow chart of exemplified processing steps from the step of obtaining source code 112 to the step of generating CRUD matrix 113 in CRUD matrix generating apparatus 100. In step S710, CPU 201 carries out static analysis of source code 112 obtained earlier. CPU 201 stores the obtained analysis data in analysis data DB 121.

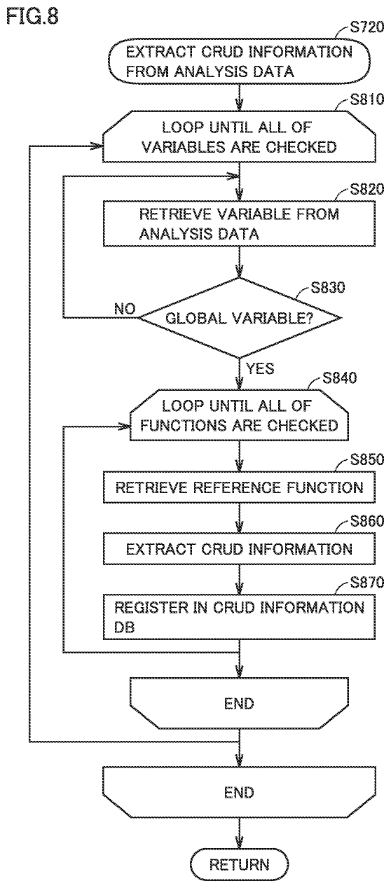

In step S720, CPU 201 extracts the CRUD information from the analysis data. Then, CPU 201 stores the CRUD information in CRUD information DB 122. Step S720 will be described in detail later with reference to FIG. 8.

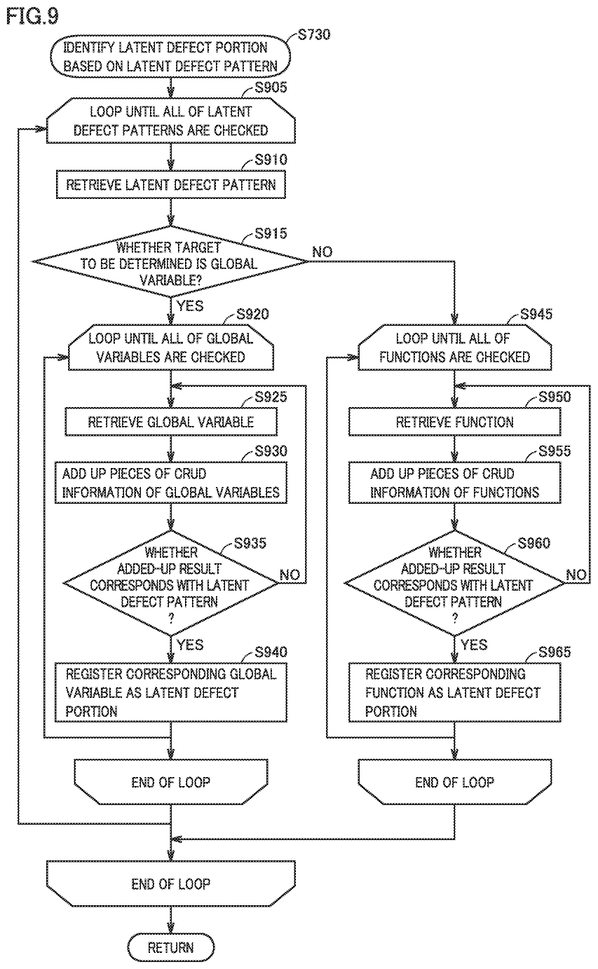

In step S730, CPU 201 identifies a latent defect portion(s) in source code 112 based on latent defect pattern 111. In an aspect, CPU 201 may store data of the latent defect portion(s) in secondary storage device 203. Step S730 will be described in detail later with reference to FIG. 9.

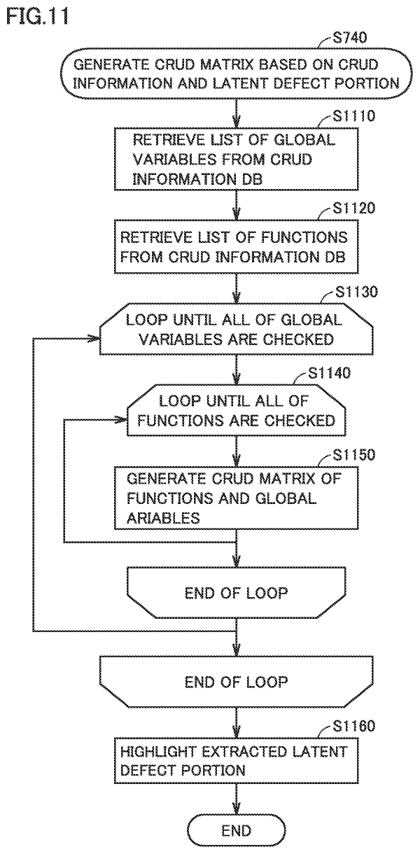

In step S740, CPU 201 generates CRUD matrix 113 based on the CRUD information and latent defect portion(s) and then outputs the generated CRUD matrix 113. In an aspect, CPU 201 may store CRUD matrix 113 in secondary storage device 203. Step S740 will be described in detail later with reference to FIG. 11.

FIG. 8 is a flow chart of exemplified processing steps of extracting the CRUD information in CRUD matrix generating apparatus 100. The process illustrated in FIG. 8 represents step S720 of FIG. 7. In step S810, CPU 201 repeatedly carries out the steps within a loop until all of the variables included in the analysis data are finally checked.

In step S820, CPU 201 retrieves the variables from the analysis data. The variables described herein refer to all of the variables included in source code 112 and may include both of global variables and local variables. In an aspect, the variable may include, for example, a structure, array, pointer, and class variable.

In step S830, CPU 201 determines whether the obtained variable is a global variable. CPU 201 proceeds to step S840 when the obtained variable is determined as a global variable (YES in step S830). Otherwise (NO in step S830), CPU 201 proceeds to step S820.

In step S840, CPU 201 repeatedly carries out the steps from step S850 to step S870 until all of the functions included in the analysis data are finally checked. In step S850, CPU 201 retrieves a reference function from the analysis data. The reference function refers to a function that runs the CRUD process for the variable obtained in step S820.

In step S860, CPU 201 extracts the CRUD information. Specifically, CPU 201 extracts the CRUD information of the reference function obtained in step S850 for the variable obtained in step S820.

In step S870, CPU 201 registers the CRUD information extracted in step S860 in CRUD information DB 122. In case the same data is already registered in CRUD information DB 122, CPU 201 may skip this step.

FIG. 9 is a flow chart of exemplified processing steps of identifying a latent defect portion(s) in CRUD matrix generating apparatus 100. The process illustrated in FIG. 9 represents step S730 of FIG. 7. In step S905, CPU 201 repeatedly carries out the steps within a loop until all of latent defect patterns 111 are finally checked. In step S910, CPU 201 retrieves latent defect pattern 111 from latent defect pattern DB 123.

In step S915, CPU 201 determines whether a target to be decided is a global variable. The target to be decided is a target to be determined whether it corresponds with latent defect pattern 111 obtained in step S910. The target to be decided may include a global variable(s) and a function(s). In an aspect, the global variable may include, for example, a structure, array, and pointer variable. In other aspects, the target to be decided may include a class(es) which includes a variable(s) and/or a function(s). CPU 201 proceeds to step S920 when the target to be decided is determined as a global variable (YES in step S915). Otherwise (NO in step S915), CPU 201 proceeds to step S945.

In step S920, CPU 201 repeatedly carries out the steps within a loop until all of the global variables are finally checked. In step S925, CPU 201 retrieves the global variables from the CRUD information.

In step S930, CPU 201 adds up pieces of CRUD information of the global variables. “The pieces of CRUD information being added up” described herein specifically refers to adding up of the number of runs of the CRUD process by each function for each global variable obtained in step S925. Taking, for example, the global variable, “g_val_01”, the CRUD process, “C(1)R(1)U(1)D(0)”, is run by the function “funcA” (for example, C(1) signifies one run of Create (C)). Further, the global variable, “g_val_01”, is subjected to the CRUD process, “C(0)R(2)U(1)D(0)”, run by the function “funcB”. In this instance, CPU 201 adds up the CRUD process, “C(1)R(1)U(1)D(0)”, run by the function “funcA” and the CRUD process, “C(0)R(2)U(1)D(0)”, run by the function “funcB”, thereby obtaining the added-up result, “C(1)R(3)U(2)D(0)”.

In step S935, CPU 201 determines whether the added-up result corresponds with latent defect pattern 111 obtained earlier. CPU 201 proceeds to step S940 when CPU 201 determines that the added-up result corresponds with latent defect pattern 111 obtained earlier (YES in step S935). Otherwise (NO in step S935), CPU 201 proceeds to step S925.

In step S940, CPU 201 registers the global variable subjected to the CRUD process that corresponds with latent defect pattern 111 as the latent defect portion. In an aspect, CPU 201 may store this result of registration in secondary storage device 203.

In step S945, CPU 201 repeatedly carries out the steps within a loop until all of the functions are finally checked. In step S950, CPU 201 retrieves the functions from the CRUD information.

In step S955, CPU 201 adds up the numbers of runs of the CRUD process by the functions obtained in step S950 (CRUD information). An example is given below, in which the function “funcA” runs the CRUD processes, “C(1)R(1)U(1)D(0)”, “C(1)R(0)U(2)D(0)” and “C(1)R(1)U(1)D(0) for each of the global variable, “g_val_01”,” g_val_02″ and “g_val_03”. Then, CPU 201 obtains the added-up result, “C(3)R(2)U(4)D(0)”, of the CRUD processes for the global variables, “g_val_01”, “g_val_02” and “g_val_03”, run by the function “funcA”.

In step S960, CPU 201 determines whether the added-up result corresponds with latent defect pattern 111 obtained earlier. CPU 201 proceeds to step S965 when CPU 201 determines that the added-up result corresponds with latent defect pattern 111 obtained earlier (YES in step S960). Otherwise (NO in step S960), CPU 201 proceeds to step S945.

In step S965, CPU 201 registers the function that runs the CRUD process that corresponds with latent defect pattern 111 as the latent defect portion. In an aspect, CPU 201 may store this result of registration in secondary storage device 203.

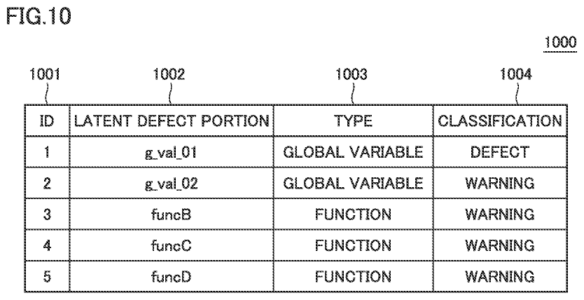

FIG. 10 is a table showing an example of data 1000 indicating latent defect portions according to this embodiment. Data 1000 of the latent defect portions are generated and registered in the processing steps illustrated in FIG. 9. Data 1000 of the latent defect portions includes, as elements, ID 1001, latent defect portion 1002, type 1003, and classification 1004.

ID 1001 uniquely identifies each of the latent defect portions included in data 1000 of the latent defect portions. Latent defect portion 1002 indicates a global variable(s) or a function(s) in which any latent defect possibly lies. Type 1003 indicates the type of latent defect portion 1002. Type 1003 may include a global variable(s) and a function(s). Classification 1004 indicates the classification of each defect. Classification 1004 may include a defect(s) and a warning(s).

FIG. 11 is a flow chart of exemplified processing steps of generating CRUD matrix 113 in CRUD matrix generating apparatus 100. The process illustrated in FIG. 11 represents step S740 of FIG. 7.

In step S1110, CPU 201 retrieves a list of global variables from CRUD information DB 122. In step S1120, CPU 201 obtains a list of functions from CRUD information DB 122. In an aspect, CPU 201 may carry out steps S1110 and S1120 at the same time.

In step S1130, CPU 201 repeatedly carries out the steps within a loop until all of the global variables obtained earlier are finally checked. In step S1140, CPU 201 repeatedly carries out the steps within a loop until all of the functions obtained earlier are finally checked. In step S1150, CPU 201 generates CRUD matrix 113 of the functions and global variables obtained from CRUD information DB 122. In step S1160, CPU 201 changes the current form of display of the latent defect portion(s) in CRUD matrix 113 to highlighted display based on data 1000 indicating latent defect portions. CPU 201 outputs CRUD matrix 113 in which the latent defect portion(s) is highlighted.

As described thus far, CRUD matrix generating apparatus 100 according to this embodiment may be equipped to analyze program source code 112 and output CRUD matrix 113 in which the latent defect portion(s) attributed to the global variable(s) being processed is highlighted and displayed. Thus, any defect(s) attributed to the global variable(s) being processed, which is conventionally very difficult to detect, may certainly be found and identified with ease.

### Second Embodiment

Next, a second embodiment is hereinafter described. This embodiment is distinct from the first embodiment in that the CRUD matrix is generated based on a task list. Any technical aspects similar to those described in the first embodiment are simply illustrated with the same reference signs and will not be described in detail again.

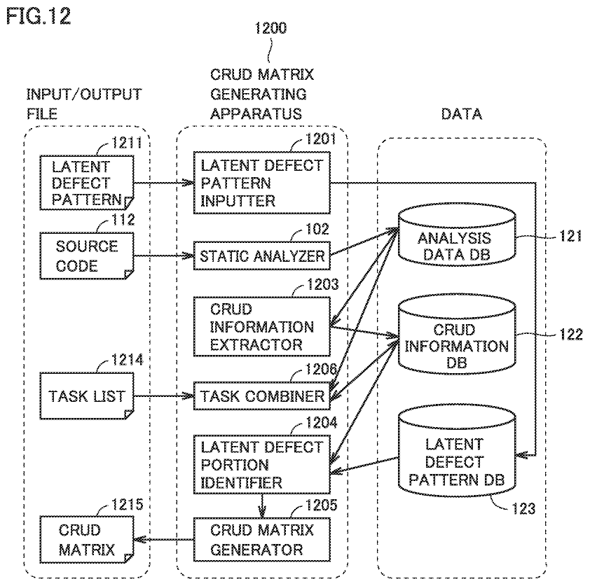

FIG. 12 is a block diagram that illustrates exemplified functional blocks of a CRUD matrix generating apparatus 1200 according to this embodiment. In an aspect, the functional blocks illustrated in FIG. 12 may be actualized under the collaboration of hardware of FIG. 2 with software.

CRUD matrix generating apparatus 1200 is equipped with a latent defect pattern inputter 1201, a static analyzer 102, a CRUD information extractor 1203, a task combiner 1206, a latent defect portion identifier 1204, and a CRUD matrix generator 1205.

A task list 1214 includes titles of tasks (functional features) and names of functions which are entry points of the tasks. The tasks may include individual functional actions in, for example, product purchase using software in online shops. The entry point function starts the processing of a relevant task.

The task combiner 1206 combines functions associated with the tasks included in task list 1214 into groups based on the obtained task list 1214. Data of the grouped functions associated with a certain task is hereinafter referred to as “task information”. Task combiner 1206 stores the task information in analysis data DB 121. This task information may be associated with the analysis data outputted from static analyzer 102.

Latent defect pattern inputter 1201 receives the input of a latent defect pattern 1211 per task. CRUD information extractor 1203 extracts the CRUD information per task based on the task information. In an aspect, CRUD information extractor 1203 may extract the CRUD information from the analysis data per function. In this instance, latent defect portion identifier 1204 may be allowed to add up pieces of CRUD information of the functions in a manner that per-task CRUD information is obtainable.

Latent defect portion identifier 1204 determines whether source code 112 includes any latent defect per task. Latent defect portion identifier 1204 determines whether source code 112 includes any latent defect based on the added-up value of pieces of CRUD information associated with a group of functions included in each task.

CRUD matrix generator 1205 generates a CRUD matrix 1215 including the CRUD information obtained for global variables per task. Any highlighted defect portions are also presented per task. The per-task CRUD information is the added-up value of pieces of CRUD information of the functions included in each task.

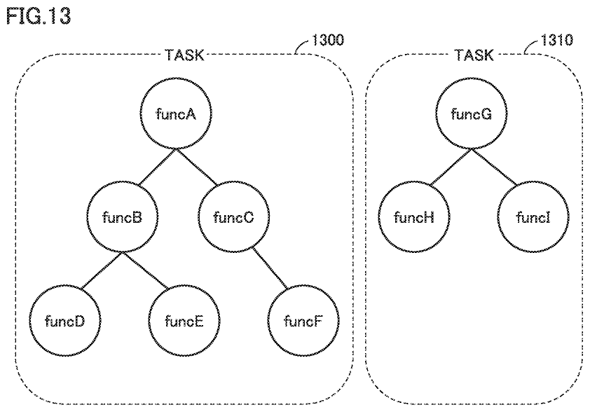

FIG. 13 is a drawing that illustrates exemplified tasks. In the example of FIG. 13, source code 112 includes a task 1300 and a task 1310 (task may otherwise be referred to as “functional feature”). Task 1300 includes the functions, “funcA”, “funcB”, “funcC”, “funcD”, “funcE”, and “funcF”. Task 1310 includes the functions, “funcG”, “funcH”, and “funcI”. In this instance, the CRUD information of task 1300 is the added-up value of pieces of CRUD information by the functions, “funcA”, “funcB”, “funcC”, “funcD”, “funcE”, and “funcF”. Also, the CRUD information of task 1310 is the added-up value of pieces of CRUD information by the functions, “funcG”, “funcH”, and “funcI”.

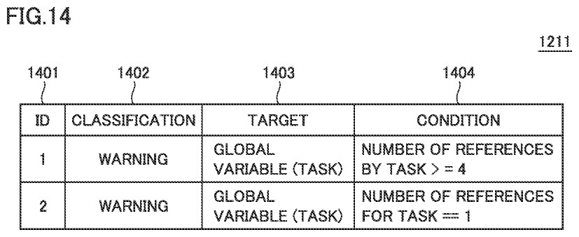

FIG. 14 is a table showing an example of latent defect pattern 1211 per task. Latent defect pattern 1211 includes, as elements, ID (Identifier) 1401, classification 1402, target 1403 and condition 1404. Latent defect pattern 1211 may be stored in latent defect pattern DB 123 in the form of a table as illustrated in, for example, FIG. 14. In an aspect, latent defect pattern 1211 may be presented in an optional data format, for example, JSON.

ID 1401 uniquely indicates each defect. Classification 1402 indicates the classification of each defect. In the example illustrated in FIG. 14, classification 1402 includes a defect(s) and a warning(s). Each defect may be classified based on, for example, the degree of possible hazard. Target 1403 indicates a target to be analyzed. Target 1403 may also include, for example, a global variable (task)(s), a global variable(s) and a function(s). The global variable (task) is characterized by per-task analysis of the relevant CRUD information. Condition 1404 indicates a condition employed to detect any latent defect portion. In the example of FIG. 14, condition 1404 includes “the number of referencing tasks>=4 (global variable referenced by four or more tasks)” and “the number of referencing tasks==1 (global variable referenced by one task alone)”.

The global variable referenced by one task alone may be replaceable with a local variable. CRUD matrix generating apparatus 1200 may be allowed to reduce the number of defect analyzing steps for source code 112 by presenting, to a user, the global variable referenced by one task alone as the refactoring index.

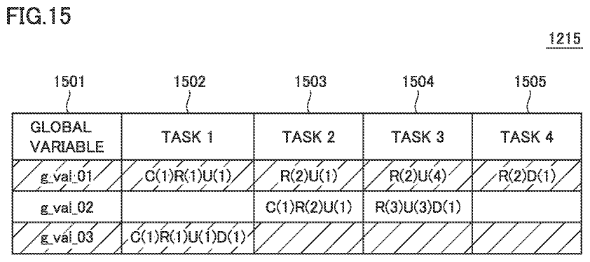

FIG. 15 is a table showing an example of CRUD matrix 1215 per task. CRUD matrix 1215 includes, as elements, a global variable 1501 and tasks 1502 to 1505. Tasks 1502 to 1505 are illustrated in this drawing by way of an example. In an aspect, CRUD matrix 1215 may include, as elements, an optional number of tasks. In the example illustrated in FIG. 15, a plurality of functions are grouped into tasks 1 to 4. The GRUD information of each task is the added-up value of pieces of CRUD information associated with functions included in each task (per-task CRUD information).

In the first row of CRUD matrix 1215, global variable 1501, “g_val_01”, is referenced by four or more tasks, which corresponds with condition 1404, “the number of referencing tasks>=4”, included in latent defect pattern 1211. This row is thus highlighted and displayed. In the third row of CRUD matrix 1215, global variable, “g_val_03”, is referenced by one task, which corresponds with the condition “the number of referencing tasks==1”, included in this latent defect pattern. This row is thus highlighted and displayed.

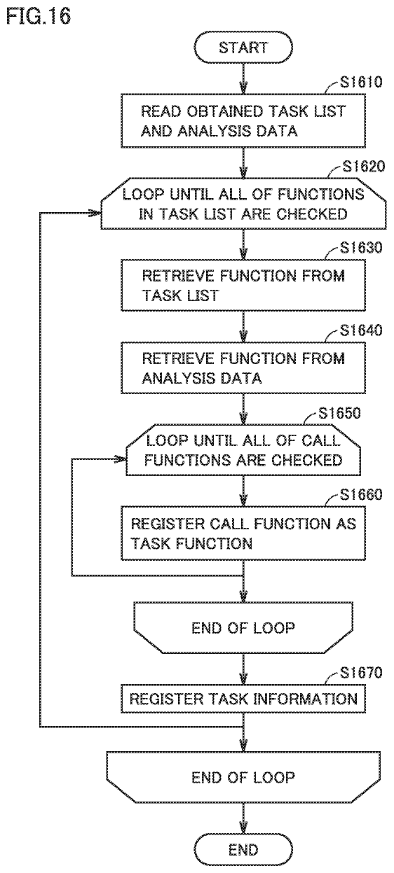

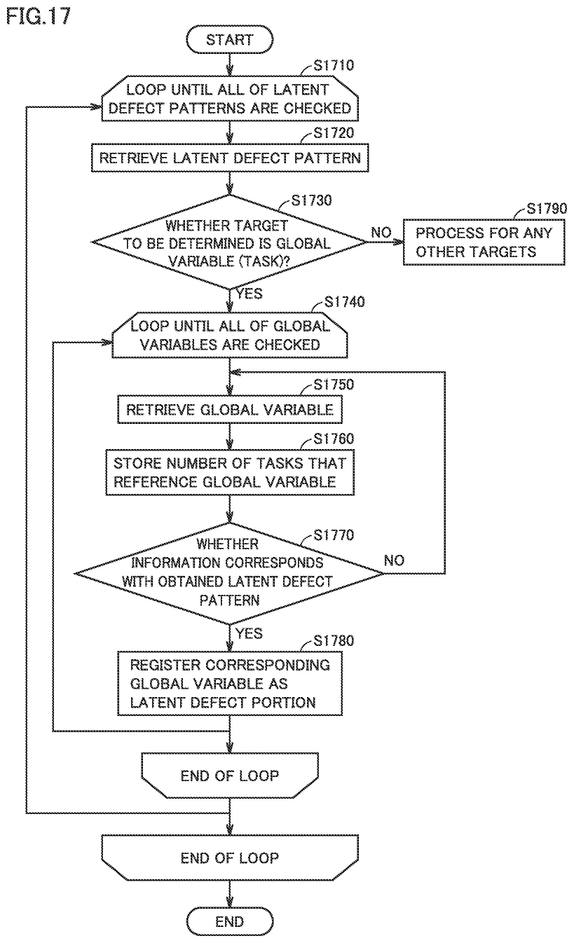

Next, steps of combining the tasks and steps of identifying the latent defect portion(s) in CRUD matrix generating apparatus 1200 are hereinafter described referring to FIGS. 16 and 17. In an aspect, CPU 201 may read out a program for the processing steps of FIGS. 16 and 17 from secondary storage device 203 into primary storage device 202 and then run the read program. In other aspects, the processing steps in whole or in part are also feasible in the form of a combination of circuit elements configured to execute these processing steps.

FIG. 16 is a flow chart of exemplified steps of combining the tasks in CRUD matrix generating apparatus 1200. In step S1610, CPU 201 reads the inputted task list 1214 and analysis data of source code 112. In an aspect, CPU 201 may obtain, instead of the analysis data, CRUD information containing function-related in formation.

In step S1620, CPU 201 repeatedly carries out the steps within a loop until all of the functions included in task list 1214 (entry point functions) are finally checked.

In step S1630, CPU 201 retrieves, from task list 1214, the entry point functions and the task titles. In step S1640, CPU 201 retrieves, from the analysis data, all of the functions included in this data.

In step S1650, CPU 201 repeatedly carries out the steps within a loop until all of the call functions are finally checked. The “call function” refers to a function directly or indirectly referenced by the entry point function. In the example illustrated in FIG. 13, the function “funcA” is the entry point function, and the functions “funcB”, “funcC”, “funcD” “funcE” and “funcF” are the call functions.

In step S1660, CPU 201, if a function among the functions in the analysis data is a call function, registers the function as task function. In an aspect, CPU 201 may register a function for each of a plurality of tasks.

In step S1670, CPU 201 registers the created task information. In an aspect, task information containing the entry point functions, call functions, task titles may be stored in secondary storage device 203.

FIG. 17 is a flow chart of exemplified processing steps of identifying a latent defect portion(s) in CRUD matrix generating apparatus 1200. In step S1710, CPU 201 repeatedly carries out the steps within a loop until all of the latent defect patterns are finally checked. In step S1720, CPU 201 retrieves latent defect pattern 1211 from latent defect pattern DB 123.

In step S1730, CPU 201 determines whether the target to be decided is a global variable (task). CPU 201 proceeds to step S1740 when the target to be decided is determined as a global variable (task(s)) (YES in step S1730). Otherwise (NO in step S1730), CPU 201 proceeds to step S1790. The target to be decided may include, other than the global variable (task(s)), an ordinary global variable(s) and function(s).

In step S1740, CPU 201 repeatedly carries out the steps within a loop until all of global variables are finally checked. In step S1750, CPU 201 retrieves the global variables from the per-task CRUD information.

In step S1760, CPU 201 obtains the number of tasks that reference the global variables obtained in step S1750 from the per-task CRUD information and store the obtained number of tasks. In an aspect, CPU 201 may obtain, other than the number of tasks that reference the global variables, information associated with an optional CRUD process.

In step S1770, CPU 201 determines whether the information stored in step S1760 corresponds with the latent defect pattern 1211 obtained earlier. CPU 201 proceeds to step S1780 when CPU 201 determines that the information stored in step S1760 corresponds with the latent defect pattern 1211 obtained earlier (YES in step S1770). Otherwise (NO in step S1770), CPU 201 proceeds to step S1740.

In step S1780, CPU 201 registers the global variable subjected to the CRUD process that corresponds with latent defect pattern 1211 as the latent defect portion. In an aspect, CPU 201 may store this result of registration in secondary storage device 203. In step S1790, CPU 201 processes any other target to be analyzed (for example, global variable(s) and function(s)). The process for any other target to be analyzed includes the steps illustrated in FIG. 9.

As described thus far, CRUD matrix generating apparatus 1200 according to this embodiment limits the target to be analyzed to any task (functional feature)-related function(s) and global variable(s) instead of analyzing the whole source code 112 containing vast amounts of data. This may allow CRUD matrix generating apparatus 1200 to efficiently identify any latent defects attributed to global variables.

### Third Embodiment

Next, a third embodiment is hereinafter described. This embodiment is distinct from the first and second embodiments in that an inter-task dependency extractor 1861 is further included other than the functional blocks according to the second embodiment. This device extracts the number of global variables shared between tasks as the degree of dependency between the tasks, and then outputs the extracted result in the form of a file.

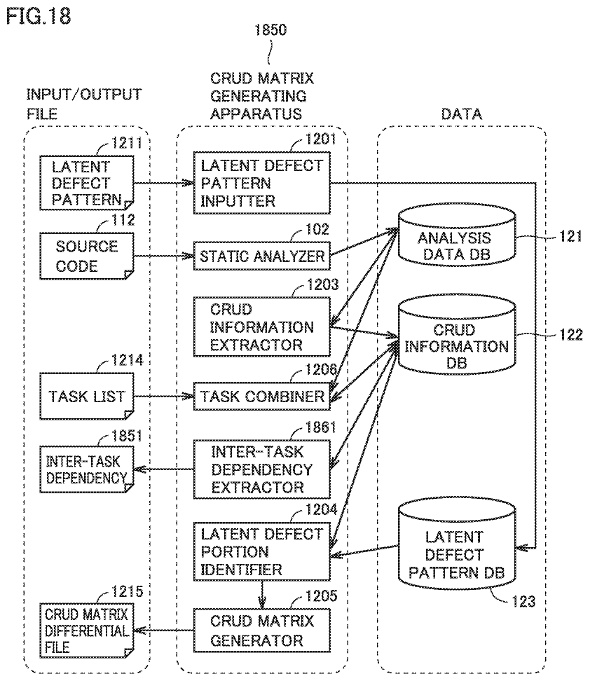

FIG. 18 is a block diagram that illustrates exemplified functional blocks of a CRUD matrix generating apparatus 1850 according to this embodiment. In an aspect, the functional blocks illustrated in FIG. 18 may be actualized under the collaboration of hardware of FIG. 2 with software.

CRUD matrix generating apparatus 1850 is equipped with inter-task dependency extractor 1861 other than the functional blocks of CRUD matrix generating apparatus 1200. Inter-task dependency extractor 1861 obtains, from CRUD information DB 122, the CRUD information per task included in source code 112; target to be analyzed. Inter-task dependency extractor 1861 extracts the number of global variables shared between tasks as the degree of dependency between the tasks. For example, inter-task dependency extractor 1861 extracts the number of global variables shared between tasks 1 and 2 as the inter-task dependency.

Inter-task dependency extractor 1861 extracts the number of global variables shared between tasks (inter-task dependency) and outputs an output file 1851 of the inter-task dependency. In the event of three or more global variables, inter-task dependency output file 1851 includes a plurality of degrees of dependency between different tasks (for example, inter-task dependency between global variables 1 and 2, inter-task dependency between global variables 2 and 3, inter-task dependency between global variables 3 and 1).

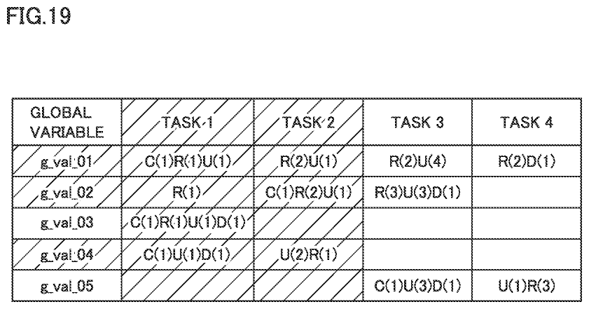

FIG. 19 is a diagram that illustrates processing steps of extracting output file 1851 of the inter-task dependency. In the example illustrated in FIG. 19, source code 112; target to be analyzed, include tasks 1 to 4 and global variables, “g_val_01”, “g_val_02”, “g_val_03”, “g_val_04”, and “g_val_05.

Inter-task dependency extractor 1861 extracts the degrees of dependency between tasks for all of combinations of tasks and embed the obtained degrees of dependency in inter-task dependency output file 1851. For example, tasks 1 and 2 share “g_val_01”, “g_val_02” and “g_val_04”. Thus, inter-task dependency extractor 1861 extracts “3” as the degree of dependency between tasks 1 and 2.

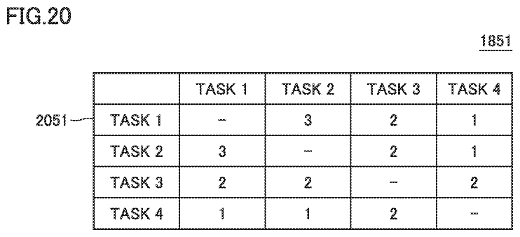

FIG. 20 is a table showing an example of inter-task dependency output file 1851. Inter-task dependency output file 1851 illustrated in FIG. 20 is generated based on the CRUD information illustrated in FIG. 19. Referring to a record 2051, for example, the degree of dependency between tasks 1 and 2 is “3”, the degree of dependency between tasks 1 and 3 is “2”, and the degree of dependency between tasks 1 and 4 is “1”.

A higher degree of dependency between tasks (shared by a greater number of tasks) may essentially make the global variables harder to control, leading to a higher risk of defects. CRUD matrix generating apparatus 1850, therefore, pursues to reduce the number of defect analyzing steps for source code 112 by presenting, to a user, the inter-task dependency (a global variable(s) with a higher inter-task dependency).

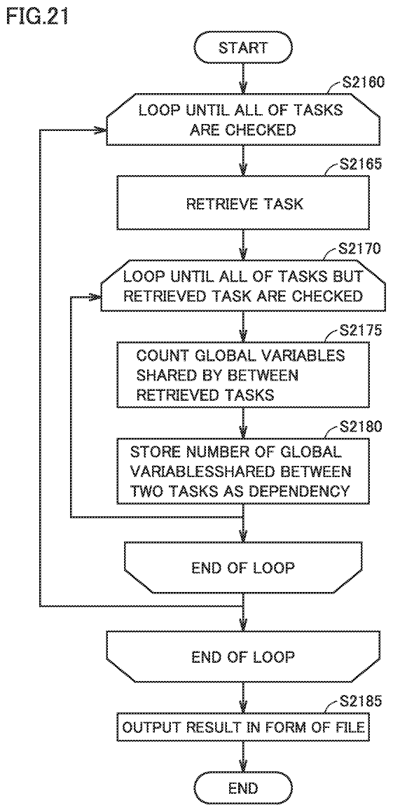

FIG. 21 is a flow chart of exemplified processing steps until output of inter-task dependency output file 1851 is completed in CRUD matrix generating apparatus 1850.

In step S2160, CPU 201 repeatedly carries out the steps within a loop until all of tasks are finally checked.

In step S2165, CPU 201 retrieves the tasks from the CRUD information which was obtained earlier from CRUD information DB 122.

In step S2170, CPU 201 repeatedly carries out the steps within a loop until any tasks but the tasks obtained in step S2165 are finally checked. Supposing that source code 112; target to be analyzed, includes tasks 1 to 5, CPU 201, when task 1 is retrieved in step S2165, carries out repeatedly the steps including step S2175 and subsequent steps until all of tasks 2 to 5 are finally checked.

In step S2175, CPU 201 counts the global variables shared between the obtained two tasks. Supposing that task 1 is obtained in step 2165 and task 2 is obtained in step S2170, for example, CPU 201 counts the global variables shared between tasks 1 and 2.

In step S2180, CPU 201 stores the counted number of global variables shared between the obtained two tasks as the inter-task dependency. In an aspect, CPU 201 may temporarily store the inter-task dependency in primary storage device 202 or secondary storage device 203.

In step S2185, CPU 201 outputs the obtained degree of dependency between the tasks in the form of a file (inter-task dependency output file 1851).

### Fourth Embodiment

Next, a fourth embodiment is hereinafter described. Differences of this embodiment to the first to third embodiments are; comparing CRUD matrices 113 before and after source code 112 is modified, and generating a CRUD matrix differential file 1815 in which a portion(s) with a higher risk of any latent defect(s) is highlighted and displayed. Any technical aspects similar to those described in the first to third embodiments are simply illustrated with the same reference signs and will not be described in detail again.

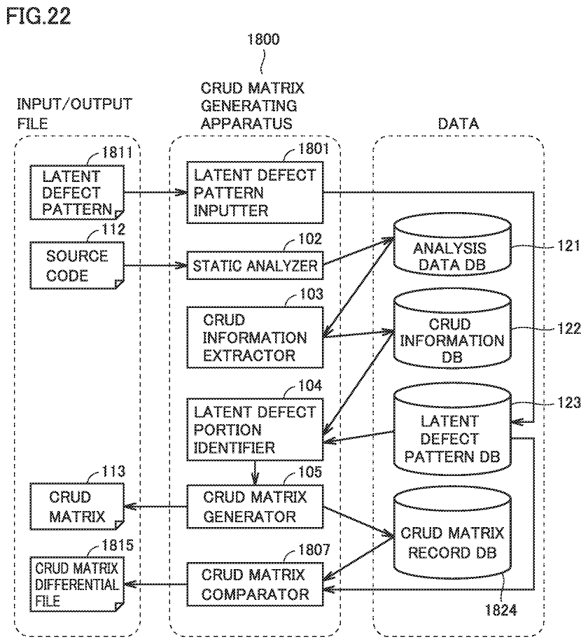

FIG. 22 is a block diagram that illustrates exemplified functional blocks of a CRUD matrix generating apparatus 1800 according to this embodiment. In an aspect, the functional blocks illustrated in FIG. 22 may be actualized under the collaboration of hardware of FIG. 2 with software.

CRUD matrix generating apparatus 1800 is equipped with a latent defect pattern inputter 1801, a static analyzer 102, a CRUD information extractor 103, a latent defect portion identifier 104, a CRUD matrix generator 105, and a CRUD matrix comparator 1807.

CRUD matrix generating apparatus 1800 generates CRUD matrix 113 through the same processing steps as those of CRUD matrix generating apparatus 100 according to the first embodiment. CRUD matrix generating apparatus 1800 stores CRUD matrix 113 generated earlier in a CRUD matrix record DB 1824. In an aspect, CRUD matrix record DB 1824 may be installed inside of CRUD matrix generating apparatus 1800 or may be installed in an external apparatus.

Latent defect pattern inputter 1801 receives, in addition to the input of regular latent defect pattern 111, the input of latent defect pattern 1811 targeted for a differential before and after update of source code 112.

CRUD matrix comparator 1807 obtains, from CRUD matrix record DB 1824, CRUD matrices 113 before and after source code 112 is modified and then outputs a differential between these CRUD matrices. CRUD matrix comparator 1807 identifies a latent defect portion(s) associated with a global variable(s) included in the differential based on latent defect pattern 1811. Thus, CRUD matrix comparator 1807 generates a CRUD matrix differential file in which a latent defect portion(s) is highlighted and displayed.

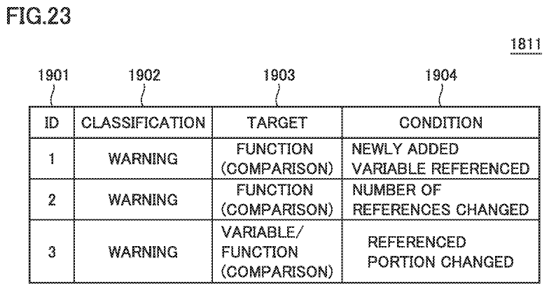

FIG. 23 is a table showing an example of latent defect pattern 1811. Latent defect pattern 1811 includes, as elements, ID (Identifier) 1901, classification 1902, target 1903, and condition 1904.

ID 1901 uniquely indicates each defect. Classification 1902 indicates the classification of each defect. For example, classification 1902 includes a defect(s) and a warning(s). Each defect may be classified based on, for example, the degree of possible hazard. Target 1903 indicates a target to be analyzed. Target 1903 may also include, for example, a global variable(s) and a function(s). The function (comparison) is an updated function (may include addition or deletion), and the global variable (addition) is a newly added global variable.

Condition 1904 indicates a condition employed to detect a latent defect portion(s). In the example illustrated in FIG. 23, condition 1904 includes “newly added variable referenced”, “number of references changed” and “referenced portion changed”. The “newly added variable referenced” indicates that a new variable(s) is referenced. The “number of references changed” indicates the number of variable references is changed“. The “referenced portions changed” indicates that a new variable(s) is referenced or a function(s) is no longer referenced.

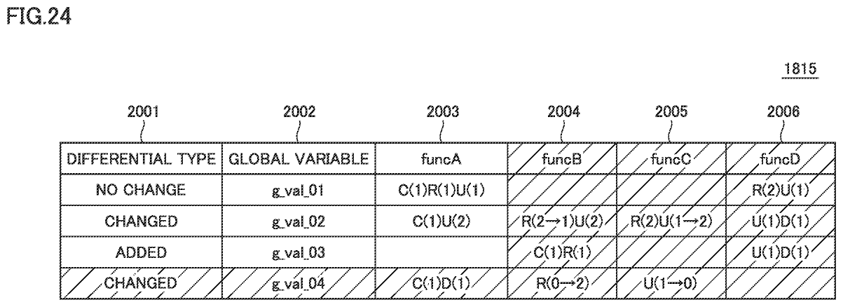

FIG. 24 is a table showing an example of CRUD matrix differential file 1815. CRUD matrix differential file 1815 includes, as elements, differential type 2001, global variable 2002, and functions 2003 to 2006. Functions 2003 to 2006 are illustrated in this drawing by way of example. In an aspect, CRUD matrix differential file 1815 may include, as elements, an optional number of functions.

Differential type 2001 indicates the type of a differential before and after update of source code 112. The “addition” indicates that a global variable(s) is added in response to update of source code 112. The “change” indicates that the number of runs of the CRUD process for the global variable(s) is changed in response to update of source code 112. The “no change” indicates that neither of “change” nor “addition” applies to the differential. In the example illustrated in FIG. 24, the number of runs of the CRUD process changed in “g_val_02” of global variable 2002, and “g_val_03” has been added to global variable 2002. Further, the number of runs of the CRUD process changed in the global variable “g_val_04”, and the global variable “g_val_04” was newly referenced by the function “funcB” (read twice) but is no longer updated by the function “funcC”.

Taking, for example, the second row in CRUD matrix differential file 1815, the functions, “funcB” and “funcC”, are highlighted as the latent defect portions because of change in the number of runs of the CRUD process for “g_val_02” of global variable 2002.

Taking, for example, the third row in CRUD matrix differential file 1815, the “g_val_03” of global variable 2002 has been added in response to update of source code 112. The functions “funcB” and “funcD”, which run the CRUD process for “g_val_03” of newly added global variable 2002, are highlighted as the latent defect portions.

Taking, for example, the fourth row in CRUD matrix differential file 1815, the CRUD process for “g_val_04” of global variable 2002 has been newly added to the function “funcB”, while the CRUD process for “g_val_04” of global variable 2002 has been deleted from the function “funcC”. Thus, these functions are highlighted as the latent defect portions.

The global variables newly referenced (or no longer referenced) and the functions that newly reference (or no longer reference) these global variables may be thus expressly identified. As a result, exclusion control or a range of impact of global variables may be easily determined. CRUD matrix generating apparatus 1800, by presenting CRUD matrix differential file 1815 to a user, may successfully reduce the steps required of defect analysis for source code 112.

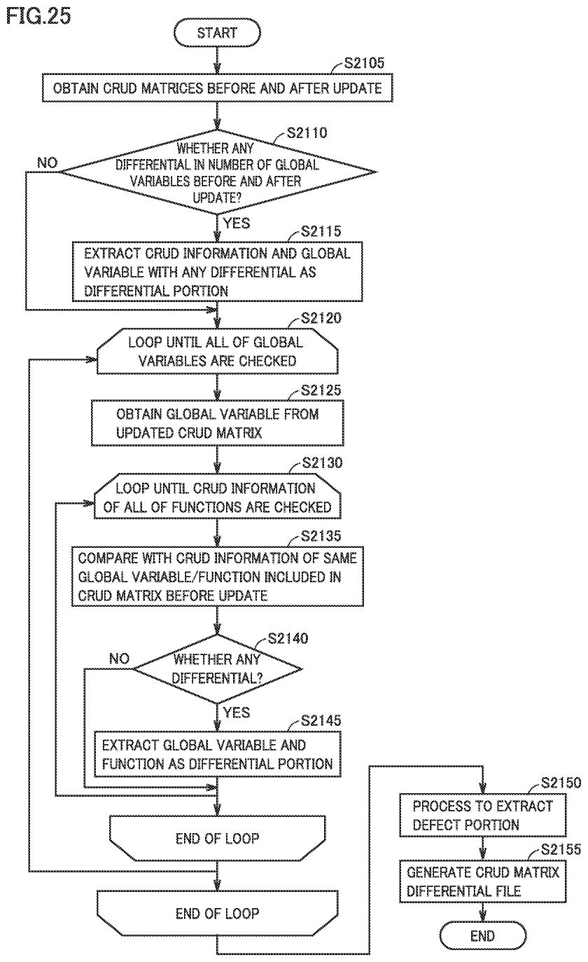

FIG. 25 is a flow chart of exemplified processing steps of generating CRUD matrix differential file 1815 in CRUD matrix generating apparatus 1800. In an aspect, CPU 201 may read out a program for the processing steps of FIG. 25 from secondary storage device 203 into primary storage device 202 and then run the read program. In other aspects, the processing steps in whole or in part are also feasible in the form of a combination of circuit elements configured to execute these processing steps. In step S2105, CPU 201 obtains, from CRUD matrix record DB 1824, CRUD matrices 113 before and after update of source code 112.

In step S2110, CPU 201 determines whether any differential is detectable in the number of global variables before and after update of source code 112. CPU 201 proceeds to step S2115 when any differential is detected in the number of global variables before and after update of source code 112 (YES in step S2110). Otherwise (NO in step S2110), CPU 201 proceeds to step S2120.

In step S2115, CPU 201 extracts the CRUD information and global variable(s) including any differential as differential portions. In step S2120, CPU 201 repeatedly carries out the steps within a loop until all of global variables are finally checked.

In step S2125, CPU 201 obtain the global variables from CRUD matrix 113 after source code 112 is updated. In step S2130, CPU 201 repeatedly carries out the steps within a loop until pieces of CRUD information of all of the functions are finally checked.

In step S2135, CPU 201 compares the CRUD information of the global variables obtained in step S2125 with the CRUD information of the same global variables included in the CRUD matrix before the update of source code 112. CPU 201 may compare the CRUD information of the functions obtained from CRUD matrix 113 after the update of source code 112 with the CRUD information of the same functions included in the CRUD matrix before the update of source code 112.

In step S2140, CPU 201 determines whether any differential is detected in the comparison of step S2135. CPU 201 proceeds to step S2145 when any differential is detected as a result of comparison in step S2135 (YES in step S2140). Otherwise (NO in step S2140), CPU 201 proceeds to step S2130.

In step S2145, CPU 201 extracts the global variable(s) and function(s) associated with the differential as differential portions. In step S2150, CPU 201 carries out the step of defect extraction. Specifically, CPU 201 identifies any latent defect included in the differential extracted in step S2145 based on latent defect pattern 1811.

In step S2155, CPU 201 generates and outputs CRUD matrix differential file 1815 based on the differential extracted in step S2145. CPU 201 changes the current form of display of the latent defect portion(s) in CRUD matrix differential file 1815 to highlighted display based on the defect(s) identified in step S2150.

As thus far described, CRUD matrix generating apparatus 1800 according to this embodiment is equipped to generate CRUD matrix differential file 1815 based on any differential between and after the update of source code 112. A user, by checking CRUD matrix differential file 1815, may easily identify any defect portion based on the update of source code 112. The technical aspects described thus far in the embodiments may be combined and used.

The embodiments disclosed herein are given by way of example in all aspects and should not be construed as limiting the scope of this disclosure. The scope of this disclosure is solely defined by the appended claims and is intended to cover the claims, equivalents, and all of possible modifications made without departing the scope of this disclosure. All of the matters disclosed in the embodiments and modified embodiments may be solely used or combined and used to the extent possible.

### REFERENCE SIGNS LIST

100, 1200, 1800, 1850: CRUD matrix generating apparatus, 101, 1201, 1801: latent defect pattern inputter, 102: static analyzer, 103, 1203: CRUD information extractor, 104, 1204: latent defect portion identifier, 105, 1205: CRUD matrix generator, 111, 1211, 1811: latent defect pattern, 112: source code, 113, 1215: CRUD matrix, 121: analysis data DB, 122: CRUD information DB, 123: latent defect pattern DB, 201: CPU, 202: primary storage device, 203: secondary storage device, 204: external device interface, 205: input interface, 206: output interface, 207: communication interface, 300: CRUD information, 301, 501, 1501, 2002: global variable, 302, 502, 503, 2003, 2006: function, 303: Create (R), 304: Read (R), 305: Update (U), 306: Delete (D), 401, 1001, 1401, 1901: ID, 402, 1004, 1402, 1902: classification, 403, 1403, 1903: target, 404, 1404, 1904: condition, 1000: data of latent defect portion, 1002: latent defect portion, 1003: type, 1206: task combiner, 1214: task list, 1300, 1310, 1502, 1503, 1504, 1505: task, 1807: CRUD matrix comparator, 1815: CRUD matrix differential file, 1824: CRUD matrix record DB, 1851: inter-task dependency output file, 1861: inter-task dependency extractor, 2001: differential type

1. A method for analyzing a source code using one or a plurality of processors, the method comprising:
obtaining a defect pattern of a program;
obtaining a source code of the program;
extracting CRUD information associated with a global variable from the source code;
identifying a latent defect from the CRUD information based on the defect pattern; and
outputting a CRUD matrix including information of the latent defect.

2. The method according to claim 1, wherein
the outputting the CRUD matrix including information of the latent defect comprises highlighting and displaying information of the latent defect included in the CRUD matrix.

3. The method according to claim 1, wherein
the identifying the latent defect from the CRUD information based on the defect pattern comprises identifying the latent defect for each global variable included in the source code.

4. The method according to claim 1, wherein
the identifying the latent defect from the CRUD information based on the defect pattern comprises identifying the latent defect for each function included in the source code.

5. The method according to claim 1, further comprising obtaining a task list including one or a plurality of functions, wherein
the extracting the CRUD information associated with the global variable from the source code comprises extracting the CRUD information associated with the global variable for each task.

6. The method according to claim 5, wherein
the extracting the CRUD information associated with the global variable for each task comprises identifying, as a latent defect portion, a global variable referenced by one task in case the global variable referenced by one task is detected.

7. The method according to claim 5, further comprising:
extracting a degree of dependency between tasks; and
outputting the degree dependency between the tasks in a form of a file.

8. The method according to claim 1, further comprising:
storing the CRUD matrix generated earlier in a CRUD matrix storage;
obtaining, from the CRUD matrix storage, a first CRUD matrix in the source code before update and a second CRUD matrix in the source code after update;
identifying a differential between the first CRUD matrix and the second CRUD matrix; and
outputting information of the latent defect included in the differential.

9. The method according to claim 8, wherein the identifying the differential between the first CRUD matrix and the second CRUD matrix comprises identifying a change in the number of the global variables.

10. The method according to claim 8, wherein the identifying the differential between the first CRUD matrix and the second CRUD matrix comprises identifying a change in the number of Create, Read, Update or Delete in one of the global variables.

11. The method according to claim 10, wherein the Create of the global variable comprises generating an instance of the global variable or dynamically securing a memory region for the global variable.

12. The method according to claim 10, wherein the Delete of the global variable comprises discarding an instance of the global variable or releasing the memory region secured for the global variable.

13. The method according to claim 8, wherein the identifying the differential between the first CRUD matrix and the second CRUD matrix comprises identifying, as a latent defect portion, the global variable that changed in the number of references by the function.

14. A non-transitory computer-readable medium storing a program for causing one or a plurality of processors to execute instructions, the instructions comprising:
obtaining a defect pattern of a program;
obtaining a source code of the program;
extracting CRUD information associated with a global variable from the source code;
identifying a latent defect from the CRUD information based on the defect pattern; and
outputting a CRUD matrix including information of the latent defect.

15. (canceled)

16. The non-transitory computer-readable medium according to claim 14, wherein:
outputting the CRUD matrix including information of the latent defect comprises highlighting and displaying information of the latent defect included in the CRUD matrix.

17. The non-transitory computer-readable medium according to claim 14, wherein:
identifying the latent defect from the CRUD information based on the defect pattern comprises identifying the latent defect for each global variable included in the source code.

18. The non-transitory computer-readable medium according to claim 14, wherein:
identifying the latent defect from the CRUD information based on the defect pattern comprises identifying the latent defect for each function included in the source code.

19. The non-transitory computer-readable medium according to claim 14, further comprising obtaining a task list including one or a plurality of functions, wherein:
extracting the CRUD information associated with the global variable from the source code comprises extracting the CRUD information associated with the global variable for each task.

20. The non-transitory computer-readable medium according to claim 19, wherein:
extracting the CRUD information associated with the global variable for each task comprises identifying, as a latent defect portion, a global variable referenced by one task in case the global variable referenced by one task is detected.

21. An apparatus, comprising:
a memory storing a program comprising instructions; and
a processor to execute the instructions,
the instructions comprising:
obtaining a defect pattern of a program;
obtaining a source code of the program;
extracting CRUD information associated with a global variable from the source code;
identifying a latent defect from the CRUD information based on the defect pattern; and
outputting a CRUD matrix including information of the latent defect.
